(19) United States
(12) Patent Application Publication
(10) Pub. No.: US 2019/0380356 A1
(43) Pub. Date: Dec. 19, 2019

(54) METHOD FOR PROCESSING COFFEE CHERRIES USING DEEP SEA WATER AND MICROORGANISMS

(71) Applicant: WELL-BEING LS CO.,LTD, Gangneung-si, Gangwon-do (KR)

(72) Inventors: Jong-Soon PARK, Gangneung-si (KR); Dong-Jin LEE, Chuncheon-si (KR); Deuk-Sik LEE, Gangneung-si (KR)

(73) Assignee: WELL-BEING LS CO.,LTD, Gangneung-si, Gangwon-do (KR)

(21) Appl. No.: 16/095,318

(22) PCT Filed: May 4, 2017
(86) PCT No.: PCT/KR2017/004705

§ 371 Date: Oct. 19, 2018

(30) Foreign Application Priority Data
May 4, 2016 (KR) 10-2016-0055665

(51) Int. Cl. A23F 5/02; A23F 5/04

(52) U.S. Cl. CPC A23F 5/02; A23F 5/04; A23Y 2220/03; A23Y 2220/35; A23Y 2220/67

(57) ABSTRACT

The present invention relates to a method for processing coffee cherries using deep seawater and microorganisms. The method processes coffee cherries by using microorganisms and deep seawater, such that the amount of defective coffee cherries are reduced, a processing time of green beans is shortened, and a content of trigonelline which is a precursor of an aroma component of coffee is increased.

### TECHNICAL FIELD

The present invention relates to a method for processing coffee cherries using deep sea water and microorganisms, and more particularly, to a method for processing coffee cherries using deep sea water and microorganisms so as to shorten the time period of processing green beans, to reduce the number of defective beans of coffee cherries and to increase trigonelline that is an aroma precursor of coffee.

### BACKGROUND ART

Since the late 1990s, global companies such as Starbucks have branched out into and have played leading roles in the South Korean coffee market. In recent years, such companies have dominated the coffee market for read-to-drink (RTD) beverages with their compelling market positioning.

As the coffee market is growing rapidly, local companies also have started to enter the market. Thus, domestic and foreign coffee manufacturers have to face fierce competition.

In 2009, South Korea's coffee consumption per capita was 1.93 kg, which was much lower than that of the U.S. (4.1 kg) and the EU (4.8 kg), and reached only 60% of that of Japan, a country which has a dietary pattern similar to that of South Korea. However, the Korean coffee market is expected to grow continuously thanks to the improvement in the standard of living and the expansion of consumption in Korea.

Meanwhile, deep sea water commonly refers to water in a region where sun light does not reach and exists 200 m below the sea surface. Deep sea water contains 3.5% of salt and its temperature is 2° C. or below. Additionally, deep sea water abounds in nutrient salts essential for the growth of marine plants and has little organic matter and few pathological bacteria.

That is, deep sea water is water that is clear, has a low temperature and abounds in minerals. Thus, there is an urgent need to develop technologies for manufacturing agricultural products in large quantities and manufacturing high-quality agricultural products and to develop environmentally friendly agricultural technologies so as to manufacture and supply organic, high-quality and highly functional farm produce in a stable manner with deep sea water.

As related arts, Korean Patent Laid-Open Publication No. 10-2015-0141009 titled “Preparation method of coffee using seawater and coffee thereby”, Korean Patent Laid-Open Publication No. 10-2015-0139157 titled “Manufacturing method of dutch coffee” and Japan Patent Laid-Open Publication No. 10-2002-034525 titled “Extract drink using marine deep water” have been disclosed.

However, in the related arts mentioned above, deep sea water is used only in the process of extracting coffee from coffee beans, and unlike the present invention, the related arts do not disclose a method for processing coffee cherries using deep sea water and microorganisms at all.

### DISCLOSURE OF INVENTION

### Technical Problem

The present invention provides a method for processing coffee cherries using deep sea water and beneficial microorganisms isolated from food so as to shorten the time period for processing coffee cherries into green beans, to reduce the number of defective beans of coffee cherries and to increase trigonelline that is an aroma precursor of coffee.

### Solution to Problem

The present invention provides a method for processing coffee cherries using deep sea water and microorganisms by a natural, a pulped natural or a washed method.

### Advantageous Effects

The present invention provides an improved method in which coffee cherries are processed with deep sea water and microorganisms such that the time period for processing coffee cherries into green beans is shortened, the number of defective beans of coffee cherries is reduced and trigonelline that is an aroma precursor of coffee is increased, and which may be commercialized thereby producing value-added green beans that have higher trigonelline content than green beans processed by traditional methods.

### BRIEF DESCRIPTION OF THE DRAWINGS

FIG. 1 shows the harvesting of coffee cherries and shows harvested coffee cherries.

FIG. 2 shows green coffee beans being processed by a traditional method.

FIG. 3 shows identification of fermentation microorganisms from coffee cherries.

FIGS. 4 to 6 show results of 16s rRNA sequencing analyzed by Genotech.

FIG. 7 shows flowcharts of traditional methods for processing coffee.

FIG. 8 shows coffee cherries being processed by traditional methods.

FIG. 9 shows defective beans produced in the process of fermentation.

FIG. 10 shows flowcharts of the processing of coffee cherries by inoculating with microorganisms.

FIG. 11 shows coffee cherries fermented with microorganisms according to processing methods.

FIG. 12 shows coffee cherries fermented by a natural processing method for 48 hours.

FIG. 13 shows the cleansing of fermented coffee cherries and the removing of mucilage thereof after the pulping of the fermented coffee cherries.

FIG. 14 shows fermented coffee cherries after hot air drying.

FIG. 15 shows fermented green beans in which parchment is removed.

FIG. 16 shows fermented green beans in which parchment is removed according to each processed group after fermented coffee cherries are dried.

FIG. 17 shows a graph of a standard (100 ppm) peak and RT of trigonelline.

FIG. 18 shows a graph of the peak of coffee beans treated with deep sea water and microorganisms and processed by a natural processing method thereby having the highest trigonelline content.

FIG. 19 shows a graph of trigonelline content of green beans treated with deep sea water according to treatments and processing methods.

FIG. 20 shows a graph of trigonelline content of coffee fermented with deep sea water compared to that of traditional best-quality coffee.

### BEST MODES FOR CARRYING OUT THE INVENTION

The present invention relates to a method for processing coffee cherries treated with deep sea water by using microorganisms through a natural processing method, a pulped natural processing method or a washed processing method such that high-quality green coffee beans in which bioactive components increase are processed.

According to the present invention, a method for processing coffee cherries using deep sea water and microorganisms, may include: quickly removing mucilage by injecting microorganisms into coffee cherries and fermenting the coffee cherries; adding deep sea water to the coffee cherries at the time of injecting the microorganisms; and removing the pulp and mucilage of the coffee cherries, drying and roasting the coffee cherries so as to increaser the content of trigonelline that is an aroma precursor of coffee after fermenting the coffee cherries.

Preferably, the microorganisms consist of at least three selected from a group consisting of Saccharomyces cerevisiae, Pichia kluyveri, Lactobacillus sakei, Lactobacillus brevis, Lactobacillus casei, Lactobacillus paracasei, Lactobacillus plantarum, Leuconostoc mesenteroides, Pediococcus pentosaceus, Lactobacillus lactis, Leuconostoclactis, Leuconostoc citreum, Lactobacillus rhamnosus, Lactobacillus, fermentum and Lactobacillus acidophilus. However, the microorganisms are not limited to the above-described ones.

Preferably, the microorganisms are Lactobacillus plantarum LS-801, Lactobacillus fermentum LS-802 and Lactobacillus acidophillus LS-803 that are strains isolated from coffee cherries.

Preferably, 1 to 7% (w/w) of the microorganisms are injected so as to reduce the number of defective beans among processed green beans and the time period (production time period) for producing green beans and to increase the content of trigonelline.

Preferably, 2 to 4% (w/w) of the deep sea water is added.

Preferably, the fermentation is completed when mucilage of the coffee cherries being fermented is completely decomposed.

Preferably, the fermentation is performed for 24 to 96 hours.

Preferably, the fermented green coffee beans are dried at 10 to 50° C. so as to have a water content of 10 to 11%.

In addition, the present invention relates to green coffee beans processed by the above-described method.

Green coffee beans of the present invention are processed by the above-described methods, thereby reducing the production time period and the number of defective beans, and increasing the content of trigonelline that is an aroma precursor of coffee during the period of processing coffee cherries into green beans.

In addition, the present invention relates to coffee made of the above-described green coffee beans.

Coffee according to the present invention is of high quality and has an intensified flavor as the coffee is made of the coffee in which the content of trigonelline, an aroma precursor of coffee, increases.

The present invention will be described in more detail with reference to the following description of embodiments and the attached drawings. However, the present invention may be embodied in many different forms, and should not be construed as being limited to the embodiments set forth herein.

<Embodiment 1> Analysis of Components in Traditional Coffee

In terms of trigonelline content, the result of the comparison among green coffee beans that ranked first and second in the 2014 Cup of Excellence (COE) competition, the specialty-grade green beans on the market, and Kopi Luwak coffee beans are listed in Table 1 below.

TABLE 1

| Sample Name | Cultivar | Grade |
|---|---|---|
| Guatemala Kalibus La | Geisha | Specialty (2014/COE#1) |
| Sierra | | |
| Guatemala El injerto | Catuai, Bourbon | Specialty (2014/COE#2) |
| Luwak | Abyssinia | — |
| Blue Mountain | Blue Mountain | Specialty |

One kilogram of all samples are roasted (lightness value called a city roast: 20 to 25) for about 15 minutes at 130° C. using a 1 kg proster coffee roaster of Taehwan Inc. Each 30 g obtained from the roasted samples is ground for 1 minute using Hood Mixer FM-909T of Hanil Electric Inc. After the grinding of the roasted samples, 24 g of ground coffee powder is sifted through a sieve of 30th mesh (600 μm) of Chenggaesang Construction and obtained.

Three hundred millimeters of the third distilled water of 98° is added to 3 g of a sample obtained from the coffee powder such that the sample is extracted for 10 minutes. The extracted sample is filtered using ADVAVTEC syringe filter (0.45 μm/PVDF) of Toyo Roshi Kaisha, Ltd. in Japan such that a final sample for measurement is prepared.

Below, Table 2 shows roasting conditions for traditional best-quality green beans.

TABLE 2

| | | Initial | | | | | | | | |
|---|---|---|---|---|---|---|---|---|---|---|
| | | temperature | | Level of | | | | | | |
| | L | for roasting | Quantity of | heat | First | | Second | | | |
| Green Bean | value | coffee beans | coffee beans | strength | crack | | crack | | Release | |
| Guatemala | 25 | 130° C. | 300 g | Medium | 12 | min | 15 | min | 15 | min |
| Kalibus | | | | | 20 | sec | 25 | sec | 30 | sec |
| La Sierra | | | | | 159° | C. | 168° | C. | 169° | C. |
| Guatemala | 25 | 130° C. | 300 g | Medium | 12 | min | 15 | min | 15 | min |
| El injerto | | | | | 00 | sec | 8 | sec | 13 | sec |
| | | | | | 156° | C. | 167° | C. | 167° | C. |
| Luwak | 25 | 130° C. | 300 g | Medium | 12 | min | 15 | min | 15 | min |
| coffee | | | | | 05 | sec | 7 | sec | 11 | sec |
| | | | | | 160° | C. | 169° | C. | 170° | C. |
| Blue | 25 | 130° C. | 300 g | Medium | 12 | min | 15 | min | 15 | min |
| Mountain | | | | | 09 | sec | 16 | sec | 21 | sec |
| | | | | | 151° | C. | 170° | C. | 170° | C. |

<Embodiment 2> Screening Fermentation Microorganisms from Coffee Cherries

For the isolation of strains of beneficial microorganisms such as Lactobacillus sp., Bacillus sp. etc., the strains are selected through isolation and identification of microorganisms originated from coffee and fermented coffee. The fermented strain held by Well-being LS Co, Ltd. is also reviewed for fermentation suitability.

Coffee cherries being now cultured are processed by a natural processing method, a pulped natural processing method or a washed processing method. The natural processing method is a process for removing pulp and parchment after sun drying coffee for about 30 to 45 days. While being sun-dried, green coffee beans are fermented and decayed.

The state where coffee cherries dried for ten days are fermented or decayed may be confirmed. In this case, the coffee cherries are picked up and ground, and samples are prepared only with fermented coffee cherries.

The pulped natural processing method is a process for drying coffee for about 20 days in the shade after removing pulp of the coffee and then removing the parchment of the coffee. Coffee is fermented or decayed when coffee is dried in the shade. Mucilage begins to harden when coffee is dried for about 7 days in the shade. At this point, green beans in the state of parchment are picked up, and only coffee beans not contaminated by mold are picked up and samples are prepared.

The washed processing method is a process for removing pulp, submerging coffee in the state of slippery mucilage in a water tank, fermenting the same, removing the mucilage and drying green beans in which the mucilage is removed so as to produce green beans. A complex chemical reaction among yeast, mold, Bacillus sp. and Lactobacillus sp. occurs when coffee is soaked and fermented in a water tank. At the time when mucilage is removed, water in the water tank is obtained such that a sample is prepared.

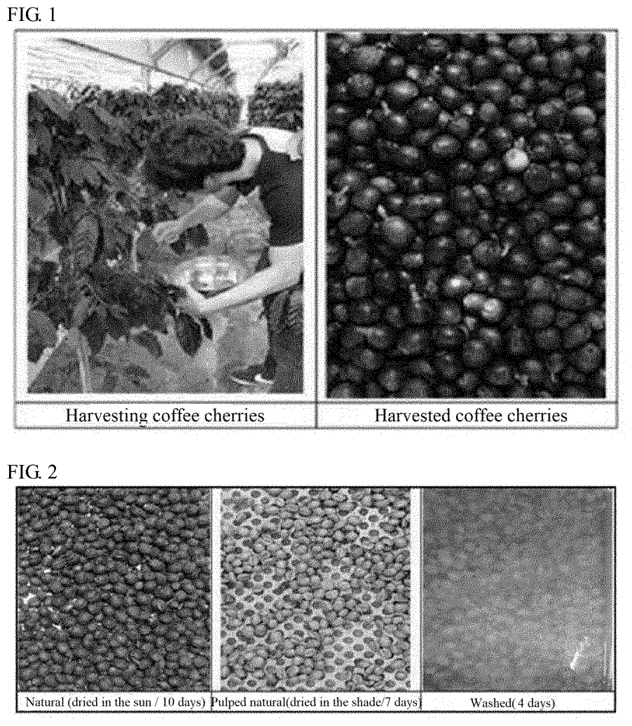

FIG. 1 shows the harvesting of coffee cherries and harvested coffee cherries in Kangwon National University in South Korea, and FIG. 2 shows green coffee beans being processed by a traditional method.

Ten grams (10 ml) of a sample obtained through the above-described method is suspended in a sterilized saline solution of 90 ml and reacts for one hour at 37° C. The reaction solution of 100 ml is smeared on nutrient agar (NA), yeast mold agar (YM) and MRS agar (MA) respectively, and cultured for 24 to 48 hours at 37° C.

As the colony cultured in this way has various strains, the strains are classified on the basis of the colors and shapes of the colony so as to isolate a single strain. The classified colony is three to five times smeared and cultured for 24 to 48 hours at 37° C. in an incubator. Then a single colony is obtained.

To confirm whether a strain is purely isolated from a single colony, the classified colony is injected into each broth medium and is suspended and cultured for about 12 hours at 90 rpm at 39° C. Then the shape of cells is observed through a phase contrast microscope. If two or more cells are observed through the phase contrast microscope, the classified colony is isolated again.

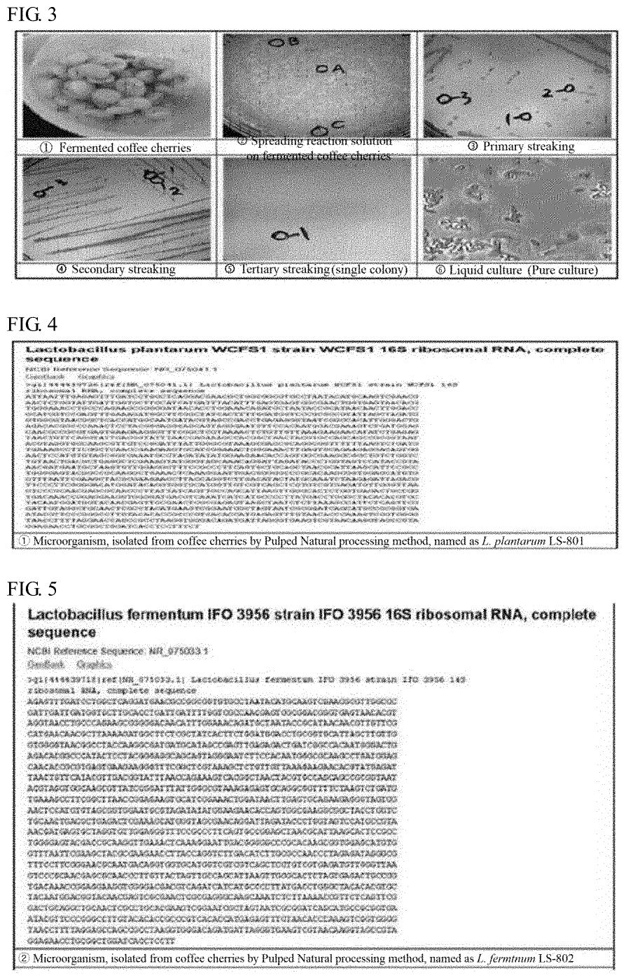

FIG. 3 shows identification of fermentation microorganisms from coffee cherries.

<Embodiment 3> Identification of Fermentation Microorganisms from Coffee Cherries

Strains are identified by 16S rRNA sequencing after the screening of beneficial microorganisms. These microorganisms are used at the time of fermentation. The identification of microorganisms is analyzed by Genotech, a professional analyzing company, and results of the identification are sent from the company. As a result of comparison with NCBI databases, the results of the identification of microorganisms are obtained. Only GRAS grade microorganisms are selected.

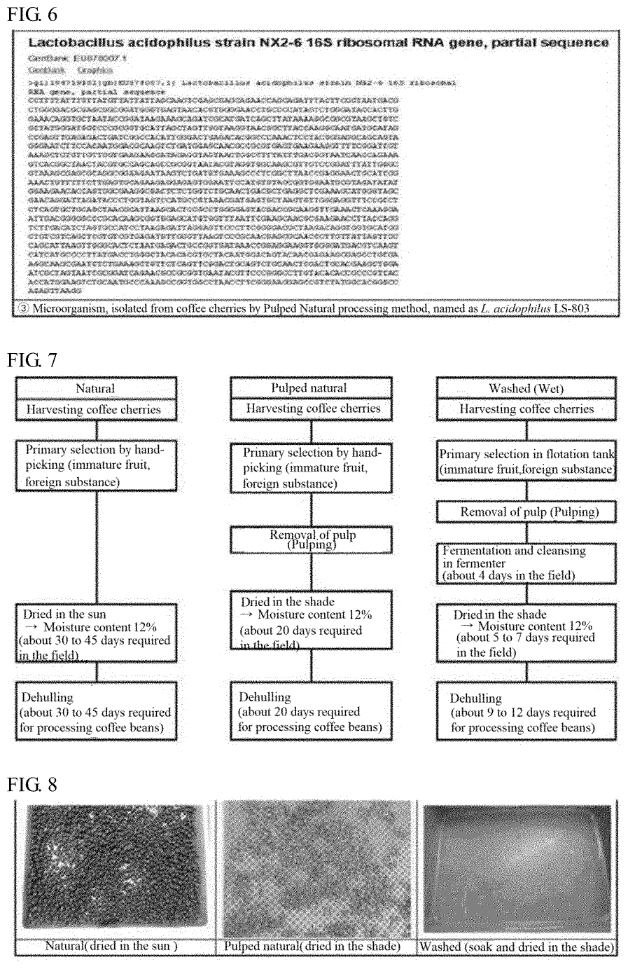

FIGS. 4 to 6 show results of 16s rRNA sequencing analyzed by Genotech. FIG. 4 shows strains of L. plantarum LS-801 isolated from fermented coffee cherries (pulped natural processing method), FIG. 5 shows strains of L. fermentum LS-802 isolated from fermented coffee cherries (natural processing method), and FIG. 6 shows strains of L. acidophilus LS-803 isolated from fermented coffee cherries (a natural method).

<Embodiment 4> Conditions for the Fermentation of Coffee Cherries

For the fermentation of harvested coffee, an experiment on the setting up of the conditions for fermentation such as a time period for fermentation, temperature for fermentation, concentration of microorganisms etc. was performed.

The above-described natural and washed processing methods have advantages and disadvantages respectively. Green coffee beans, processed by the natural processing method, may taste good depending on types of microorganisms being fermented and the degree in which coffee cherries are ripened, even in the case of the same sort of green beans. However, if green coffee beans are decayed, the defective beans (flawed beans) taste bad. Beans processed by the washed processing method taste good to a certain degree. However, the sensory preference of beans processed by the washed processing method is worse than that of well-fermented green beans through the natural processing method.

However, such disadvantages will be solved through the fermentation of beneficial microorganisms.

First, coffee cherries are processed through a traditional method before the coffee cherries are fermented with microorganisms. The applicant sought to find potential problems at the time of the fermentation of coffee cherries.

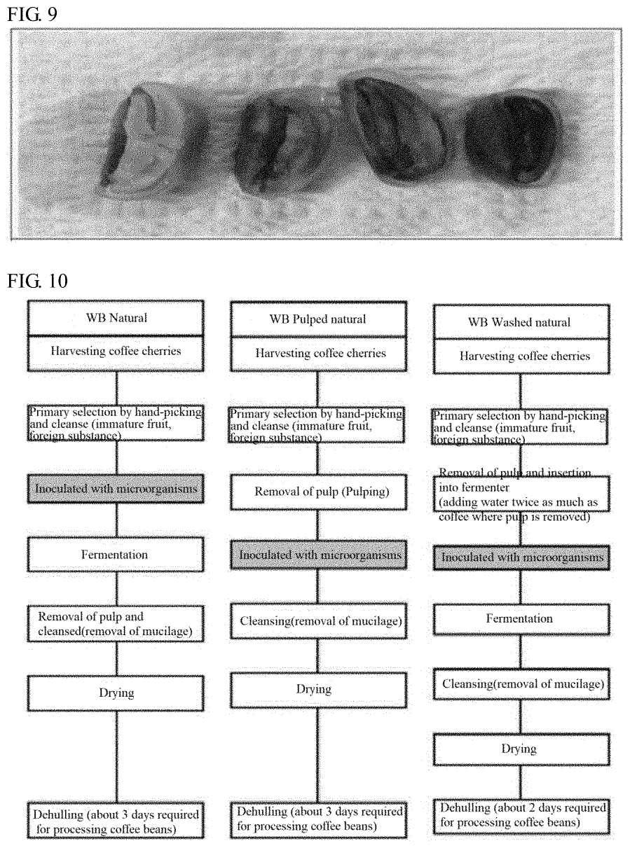

FIG. 7 shows flowcharts of traditional methods for processing coffee, FIG. 8 shows coffee cherries being processed by traditional methods, and FIG. 9 shows defective beans produced in the process of fermentation and shows a usual green bean, a sour bean, a stinker bean (partial black bean) and a black bean from left to right.

In addition, Table 3 below shows the number of defective beans, the final yield and the processing time through traditional processing methods.

TABLE 3

| | | | | Green | | | | Processing |
|---|---|---|---|---|---|---|---|---|
| | | Pulping | | beans | | Processed | | time |
| Processing | Coffee | green | Parchment | after | Defective | green | Final | (Moisture |
| methods | cherries | beans | (dried) | dehulling | beans | beans | yield | content 12%) |
| Natural | 1,500 g | — | — | 368 g | 75 g | 293 g | 19.5% | 40 days |
| | | | | | (35 beans) | | | |
| Pulped | 1,500 g | 850 g | 472 g | 365 g | 53 g | 312 g | 20.8% | 22 days |
| Natural | | | | | (30 beans)) | | | |
| Washed | 1,500 g | 848 g | 458 g | 366 g | 46 g | 320 g | 21.3% | 11 day (cleansing |
| | | | | | (12 beans) | | | after 4 days) |

The applicant sought to establish the optimum conditions by applying screened microorganisms to the fermentation of coffee cherries and fermenting the coffee cherries by the hour, on the basis of natural, pulped natural and washed processing methods.

Coffee cherries treated with deep sea water are used. In all the natural, pulped natural and washed processing methods, three species of identified microorganisms (LS-801, 802, 803) is diluted with 1.00×10⁹ cfu/ml after the liquid culture of the microorganisms. Each strain corresponding to 1% of the weight of the coffee cherries was injected (3% of the total weight of 3.00×10⁹cfu/ml of Lactobacillus sp. is injected).

In the natural processing method, coffee cherries are directly sprayed with deep sea water, and fermented until mucilage completely decomposed and melt.

In the pulped natural processing method, green beans in the state of mucilage are separated after coffee cherries are compressed, and are fermented in the state where the pulp buried in the mucilage is not removed. In the washed processing method, water corresponding to 4 times the weight of green beans is poured on the green beans after the pulp is removed. Then the green beans are inoculated with beneficial microorganisms and are fermented at 37° C.

Three percent of deep sea water is injected at the time of fermentation, and the effects of deep sea water on microorganisms are observed when coffee cherries are fermented.

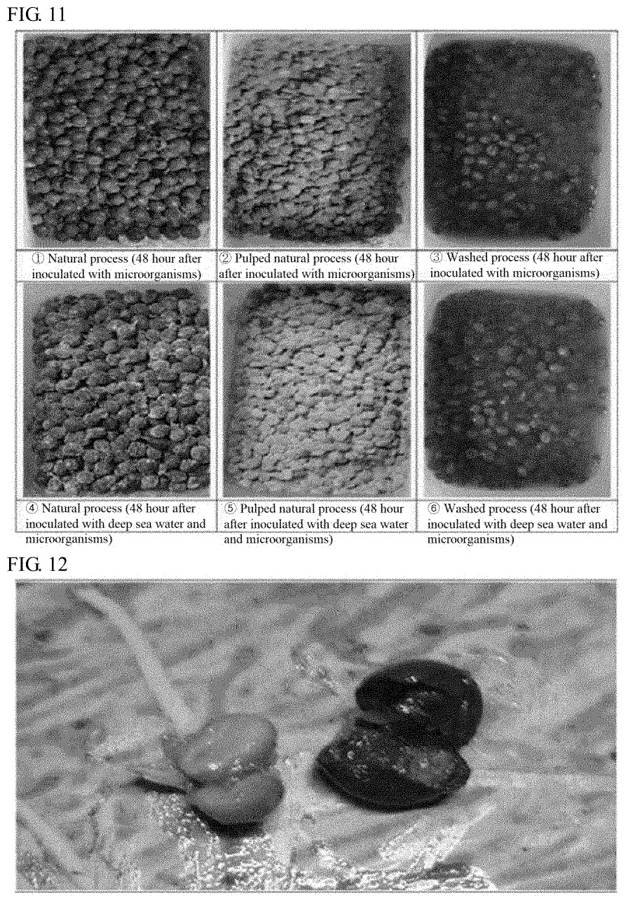

FIG. 10 shows flowcharts of the processing of coffee cherries by inoculating the coffee cherries with microorganisms, and FIG. 11 shows coffee cherries fermented with microorganisms according to each processing method.

In addition, Table 4 below shows the results of a process with fermentation microorganisms, and Table 5 below shows the results of a process with 3% of deep sea water and fermentation microorganisms.

TABLE 4

| Sample name | Number of cells (cfu/g) | pH | Mucilage |
|---|---|---|---|
| Natural | Lactobacillus sp.: 6.20 × 10⁷ | 4.81 | Decomposed X |
| process 24 hr | Yeast: 5.90 × 10⁷ | | |
| Natural | Lactobacillus sp.: 2.36 × 10⁸ | 4.51 | Decomposed ◯ |
| process 48 hr | Yeast: 3.25 × 10⁸ | | |
| Pulped natural | Lactobacillus sp.: 4.20 × 10⁷ | 5.53 | Decomposed X |
| process 24 hr | Yeast: 3.10 × 10⁷ | | |
| Pulped natural | Lactobacillus sp.: 6.20 × 10⁸ | 5.34 | Decomposed ◯ |
| process 48 hr | Yeast: 7.80 × 10⁸ | | |
| Washed | Lactobacillus sp.: 1.10 × 10⁸ | 4.65 | Decomposed X |
| process 24 hr | Yeast: 3.40 × 10⁷ | | |
| Washed | Lactobacillus sp.: 1.12 × 10⁸ | 3.94 | Decomposed ◯ |
| process 48 hr | Yeast: 7.50 × 10⁷ | | |

TABLE 5

| Sample name | Number of cells (cfu/g) | pH | Mucilage |
|---|---|---|---|
| Natural process | Lactobacillus sp.: | 4.72 | Decomposed X |
| 24 hr | 9.90 × 10⁷ | | |
| | Yeast: 7.40 × 10⁷ | | |
| Natural process | Lactobacillus sp.: | 4.45 | Decomposed ◯ |
| 48 hr | 2.90 × 10⁸ | | |
| | Yeast: 3.86 × 10⁸ | | |
| Pulped natural | Lactobacillus sp.: | 5.45 | Decomposed X |
| process 24 hr | 2.20 × 10⁷ | | |
| | Yeast: 4.10 × 10⁷ | | |
| Pulped natural | Lactobacillus sp.: | 5.19 | Decomposed ◯ |
| process 48 hr | 9.30 × 10⁸ | | |
| | Yeast: 1.00 × 10⁹ | | |
| Washed process | Lactobacillus sp.: | 4.55 | Decomposed X |
| 24 hr | 8.35 × 10⁷ | | |
| | Yeast: 7.50 × 10⁷ | | |
| Washed process | Lactobacillus sp.: | 4.03 | Decomposed ◯ |
| 48 hr | 1.35 × 10⁸ | | |
| | Yeast: 1.50 × 10⁸ | | |

In all the natural, pulped natural and washed processes, microorganisms are fermented and dried until mucilage is isolated by the touch of a user's hand. Samples are extracted on a regular basis and the number and pH of cells of beneficial microorganisms are measured, at the time of fermentation.

At the time of fermentation, fruit flavors are produced. This is a positive effect. Microorganisms are fermented at 37° C. and are inoculated with a culture solution (1.00×10⁹ cfu/ml) of isolated microorganisms (LS-801, 802, 803) corresponding to 1% (a total of 3%) of the weight of each coffee cherry. These are the temperature for fermentation and the conditions for the inoculation of microorganisms.

In each fermentation method, fermented coffee cherries are cleansed such that mucilage is removed and are dried with a hot air dryer at 45° C. (dried at 45 to 60° C. in most areas that produce green coffee beans) so as to have 10 to 12% of moisture. As a result, beans in the state of parchment are obtained, and the archment is removed using mortar.

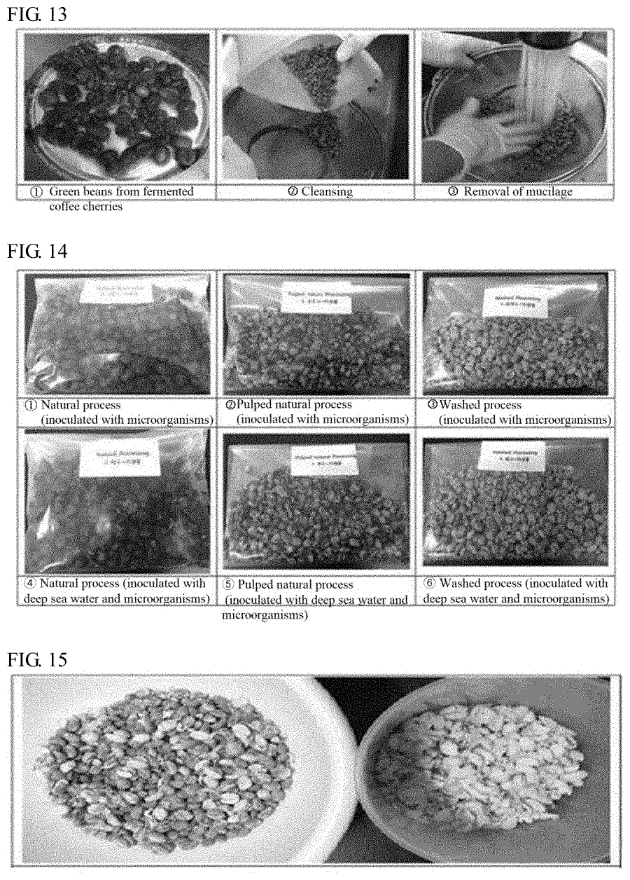

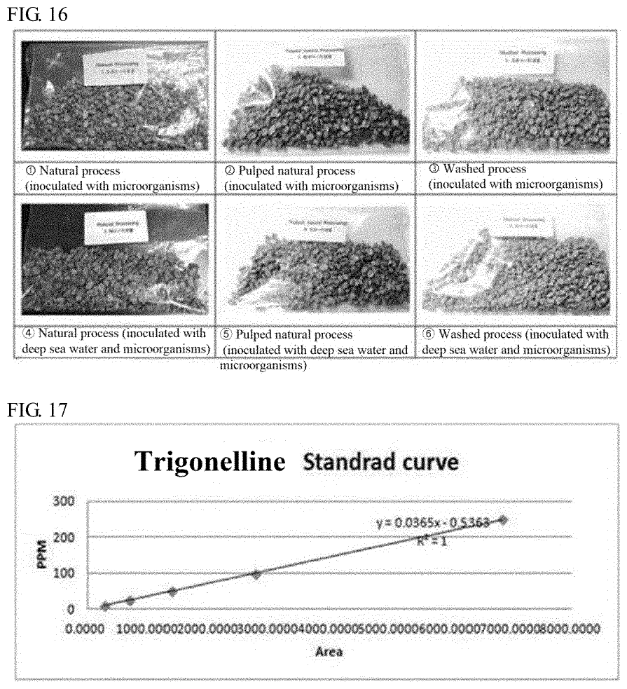

FIG. 13 shows fermented coffee cherries are cleansed and mucilage thereof is removed after the fermented coffee cherries are pulped. In addition, FIG. 14 shows fermented coffee cherries after hot air drying, and FIG. 15 shows fermented green beans in which parchment is removed.

Defective beans may be confirmed while the dried green beans are fermented. Such defective beans are rated according to a method of the Specialty Coffee Association of America (SCAA).

FIG. 16 shows fermented green beans in which parchment is removed according to each processed group after fermented coffee cherries are dried.

In addition, Table 6 below shows grades of green beans and defect coefficients determined by SCAA on the basis of defective beans, and Table 7 below shows the number of defective beans, the final yield and the processing time, compared to traditional processing methods.

TABLE 6

| | | NUMBER OF |
|---|---|---|
| | | DEFECTIVE |
| | NAME OF | COFFEE |
| GRADE | GRADE | BEANS |
| Class 1 | Specialty | 0-5 |
| | Grade | |
| Class 2 | Premium Grade | 0-8 |
| Class 3 | Exchange | 9-23 |
| | Grade | |
| Class 4 | Below Grade | 24-85 |
| Class 5 | Off Grade | Over 86 |

TABLE 7

| | | | | Green | | | | Processing | |
|---|---|---|---|---|---|---|---|---|---|
| | | Pulping | | beans | | Processed | | time | |
| Peocessing | Coffee | green | Parchment | after | Defective | green | Final | (Moisture | |
| method | cherries | beans | (dried) | dehulling | beans | beans | yield | content 12%) | |
| Traditional | 1,500 g | — | — | 368 g | 75 g | 293 g | 19.5% | 40 | days |
| Natural | | | | | (35 beans) | | | | |
| process | | | | | | | | | |
| Traditional | 1,500 g | 850 g | 472 g | 365 g | 53 g | 312 g | 20.8% | 282 | days |
| Pulped | | | | | (30 beans) | | | | |
| Natural | | | | | | | | | |
| process | | | | | | | | | |
| Traditional | 1,500 g | 848 g | 458 g | 366 g | 46 g | 320 g | 21.3% | 11 days (cleansing | |
| Washed | | | | | (12 beans) | | | after4 days) | |
| process | | | | | | | | | |
| WB Natural | 1,500 g | — | — | 366 | 15 g | 351 g | 23.4% | 4 | days |
| process | | | | | (3 beans) | | | | |
| WB Pulped | 1,500 g | 847 | 470 | 361 | 16 g | 345 g | 23.0% | 4 | days |
| Natural | | | | | (1 beans) | | | | |
| process | | | | | | | | | |
| WB Washed | 1,500 g | 855 | 463 | 364 | 20 g | 344 g | 22.9% | 3 | days |
| process | | | | | (1 beans) | | | | |
| Deep sea | 1,500 g | — | — | 362 | 19 g | 343 g | 22.9% | 4 | days |
| water WB | | | | | (2 beans) | | | | |
| Natural | | | | | | | | | |
| process | | | | | | | | | |
| Deep sea | 1,500 g | 830 | 441 | 367 | 24 g | 343 g | 22.9% | 4 | days |
| water WB | | | | | (1 beans) | | | | |
| Pulped | | | | | | | | | |
| Natural | | | | | | | | | |
| process | | | | | | | | | |
| Deep sea | 1,500 g | 851 | 460 | 374 | 20 g | 354 g | 22.9% | 3 | days |
| water WB | | | | | (1 beans) | | | | |
| Washed | | | | | | | | | |
| process | | | | | | | | | |

<Embodiment 5> Conditions for Drying Green Beans

Green beans in which coffee cherries and parchment are removed are usually dried to have a moisture content of 10 to 13%. This is because there are not enough physical changes (popping) in the process of roasting green beans when moisture content is low, and because green beans may be decayed and spoiled when moisture content is so high.

In addition, mucilage or coffee cherries are fermented and absorb various sorts of organic matter while green beans are dried. This has a great effect on coffee in sensory and functional aspects.

Generally, most green beans are sun-dried. However, the time period for drying green beans is not constant because sunlight is not constant throughout the year. In Addition, green beans are easily decayed and defective beans with an extremely small amount of moisture are easily produced for a short period of time even if the moisture content of the green beans is the same. This is because the outsides of the green beans have less moisture and the insides of the green beans have more moisture.

Thus, green coffee beans in which coffee cherries are fermented are dried by means of a hot air drier at 40 to 70° C. so as to have a moisture content of 1011%. In this case, the optimum conditions for drying green beans are established considering the drying time and the state of green beans (the number of defective beans) at the time of roasting the green beans.

In order to roast green beans, 1 kg of green beans are roasted on a high temperature with a 1 kg semi roaster and inserted for the first time at 130° C., and a damper is fixed at level 5. At this time, the first popping, the second popping and the time for a final exhaust are recorded when green beans are roasted according to drying methods.

Table 18 below shows drying time and roasting properties according to the drying temperature of green beans processed by a WB natural processing method, Table 19 below shows drying time and roasting properties according to the drying temperature of green beans processed by a WB pulped natural processing method, and Table 20 below shows drying time and roasting properties according to drying temperature of green beans processed by a WB washed processing method.

As shown in Tables 18 to 20, there is no difference in the drying time according to the processing methods. Further, there is almost no difference in roasting according to the drying temperature and drying time.

Thus, in terms of a method for drying green coffee beans, green coffee beans are dried at 45° C. so as to be stable in moisture balance.

<Embodiment 6> Analysis of Trigonelline that is an Aroma Precursor of Coffee

Trigonelline of coffee beans processed by the above-described processes is analyzed. Thirty grams of each sample is ground for 1 minute using Hood Mixer FM-909T manufactured by Hanil Electric Inc and sifted through a sieve of 30th mesh (600 μm) manufactured by Chunggye Sieve such that green coffee bean powder is obtained.

Three hundred millimeters of 70% EtOH is added to 3 g of samples taken from the obtained green coffee bean powder, and the samples are extracted at 15 rpm for 10 minutes. The extracted samples are filtered through atmospheric filtration using 100 Cerscles 5C (125 mm) filter paper of Toyo Roshi kaisha,.Ltd in Japan such that final samples for measurement is prepared.

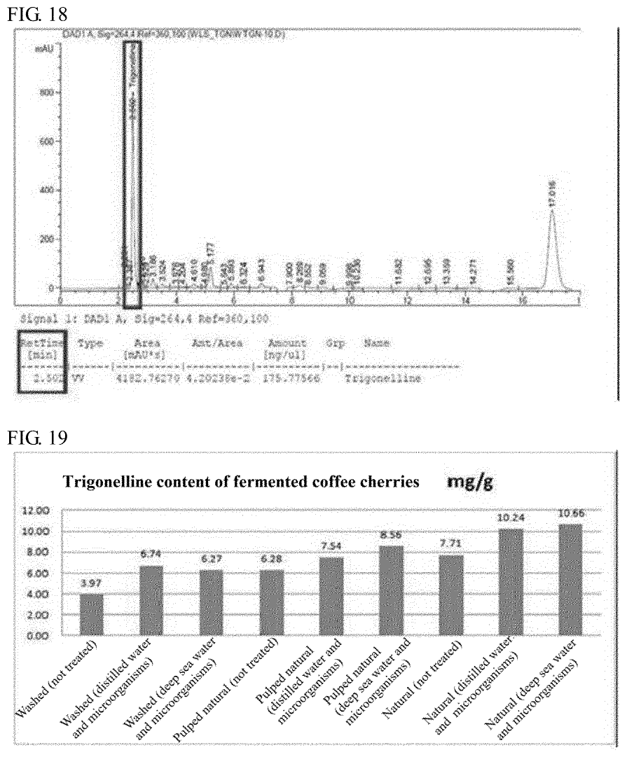

FIG. 17 shows a standard curve of trigonelline, FIG. 18 shows a graph of the peak of coffee beans that are treated with deep sea water and microorganisms and are processed by a natural processing method thereby having the highest trigonelline content, and FIG. 19 shows a graph of trigonelline content of green beans treated with deep sea water according to treatments and processing methods.

Trigonelline, an aroma precursor, produces aromas in combination with other components by heat when roasted. The higher the trigonelline content in coffee, the stronger the flavor of coffee.

It turns out that coffee, processed by a natural processing method with deep sea water and microorganisms, has the highest trigonelline content.

Overall, coffee processed by a natural processing method and treated with deep sea water and microorganisms is of high quality. Thus, coffee cherries are processed by a natural processing method and treated with deep sea water and microorganisms such that high-quality coffee is produced.

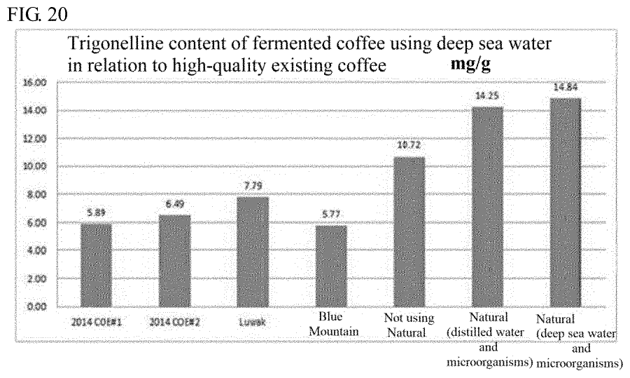

FIG. 20 shows a graph of trigonelline content of coffee cherries treated with deep sea water and then fermented with microorganisms in comparison with that of coffee cherries not treated with deep sea water (traditional coffee cherries).

The graph shows that the trigonelline content of coffee treated with deep sea water is higher than that of the control group (not treated with deep sea water and microorganisms).

As aroma components in coffee increase, the coffee may be classified as high-quality coffee in sensory aspects in the case of cupping. In particular, considering the characteristic fruit flavor of coffee cherries may be kept, high-quality coffee may be produced by means of fermentation.

The present invention has been described in connection with the preferred exemplary embodiments. However, it will be apparent to one skilled in the art to which the present invention pertains that the present invention may be changed and modified in various forms without departing from the spirit and scope of the present invention described in the appended claims.

### Industrial Applicability

The present invention, which helps improve the quality of coffee, increase the production of coffee, promote an increase in functional components for product differentiation, promote changes in physiological activities as an improved method in which green coffee beans are processed with deep sea water, may be commercialized, thereby presenting a practical model of the sixth industrialization including the production, process, commercialization and sale of coffee as a new source of income and leading to an increase in value added. Thus, the present invention may be applied to the art to which the present invention pertains.

1. A method for processing coffee cherries using deep sea water and microorganisms, comprising:
inoculating coffee cherries with microorganisms, fermenting the coffee cherries and removing mucilage quickly from the coffee cherries;
adding deep sea water to the coffee cherries when the coffee cherries are inoculated with the microorganisms; and
removing pulp and mucilage of the coffee cherries, drying and roasting the coffee cherries, and increasing trigonelline content that is an aroma precursor of coffee after fermenting the coffee cherries.

2. The method of claim 1, wherein the microorganisms are at least three selected from a group consisting of Saccharomyces cerevisiae, Pichia kluyveri, Lactobacillus sakei, Lactobacillus brevis, Lactobacillus casei, Lactobacillus paracasei, Lactobacillus plantarum, Leuconostoc mesenteroides, Pediococcus pentosaceus, Lactobacillus lactis, Leuconosto clactis, Leuconostoc citreum, Lactobacillus rhamnosus, Lactobacillus, fermentum and Lactobacillus acidophilus.

3. The method of claim 1, wherein the microorganisms are Lactobacillus plantarum LS-801, Lactobacillus fermentum LS-802 and Lactobacillus acidophillus LS-803.

4. The method of claim 1, wherein 1 to 7% (w/w) of the microorganisms are injected so as to reduce defective beans among processed green beans and production time and to increase trigonelline content.

5. The method of claim 1, wherein 2 to 4% (w/w) of the deep sea water is added.

6. The method of claim 1, wherein the fermenting of the microorganisms is completed when mucilage of the coffee cherries being fermented is completely decomposed.

7. The method of claim 6, wherein the fermenting of the microorganisms are performed for 24 to 96 hours.

8. The method of claim 1, wherein the drying of fermented green coffee beans is performed at 10 to 50° C. such that the fermented green coffee beans have a moisture content of 10 to12%.

9. Green coffee beans processed according to claim 1.

10. The green coffee beans of claim 9, have an increased content of trigonelline.

11. Coffee made of the green coffee beans of claim 9.

12. Green coffee beans processed according to claim 2.

13. The green coffee beans of claim 12, have an increased content of trigonelline.

14. Coffee made of the green coffee beans of claim 12.

15. Green coffee beans processed according to claim 3.

16. The green coffee beans of claim 15, have an increased content of trigonelline.

17. Coffee made of the green coffee beans of claim 15.

18. Green coffee beans processed according to claim 4.

19. The green coffee beans of claim 18, have an increased content of trigonelline.

20. Coffee made of the green coffee beans of claim 18.

21. Green coffee beans processed according to claim 5.

22. The green coffee beans of claim 21, have an increased content of trigonelline.

23. Coffee made of the green coffee beans of claim 21.

24. Green coffee beans processed according to claim 6.

25. The green coffee beans of claim 24, have an increased content of trigonelline.

26. Coffee made of the green coffee beans of claim 24.

27. Green coffee beans processed according to claim 7.

28. The green coffee beans of claim 27, have an increased content of trigonelline.

29. Coffee made of the green coffee beans of claim 27.

30. Green coffee beans processed according to claim 8.

31. The green coffee beans of claim 30, have an increased content of trigonelline.

32. Coffee made of the green coffee beans of claim 30.
